(19) United States
(12) Patent Application Publication
(10) Pub. No.: US 2025/0017261 A1
(43) Pub. Date: Jan. 16, 2025

(54) CONSUMABLE FOR AN AEROSOL PROVIDING DEVICE

(71) Applicant: NICOVENTURES TRADING LIMITED, London (GB)

(72) Inventor: Matthew HODGSON, London (GB)

(21) Appl. No.: 18/712,921

(22) PCT Filed: Nov. 22, 2022
(86) PCT No.: PCT/GB2022/052954

§ 371 Date: May 23, 2024

(30) Foreign Application Priority Data
Nov. 24, 2021 (GB) 2116946.1

(51) Int. Cl. A24D 1/20; A24B 15/12; A24D 1/00; A24D 1/02; A24D 1/04; A24F 40/20; A24F 40/465; H05B 6/10

(52) U.S. Cl. CPC A24D 1/20; A24B 15/12; A24D 1/008; A24D 1/02; A24D 1/045; A24F 40/20; A24F 40/465; H05B 6/105

(57) ABSTRACT

A consumable including an aerosol generating material and an additional material different to the aerosol generating material, wherein the consumable includes a means accessible to a user of the consumable to allow the additional material to be removed from the consumable by manipulation of said means.

### RELATED APPLICATIONS

The present application is a National Phase entry of PCT Application No. PCT/GB2022/052954 filed Nov. 22, 2022, which claims priority to GB Application No. 2116946.1 filed Nov. 24, 2021, each of which is hereby incorporated by reference in their entirety.

### TECHNICAL FIELD

The present invention relates to a consumable and a method of using the same.

### BACKGROUND

There is a drive toward increasing the recyclability and sustainability of consumer products to reduce potential impact on the environment. Manufacturers and suppliers may also benefit from recycling as manufacturing costs can be reduced by reusing recycled components.

There is often a difficulty in engaging consumers with recycling, particularly where the act of recycling imposes an additional burden on them, such as sorting their waste into different recyclable categories.

### SUMMARY

In accordance with some embodiments described herein, in a first aspect there is provided a consumable comprising an aerosol generating material and an additional material different to the aerosol generating material, wherein the consumable comprises means accessible to a user of the consumable to allow the additional material to be removed from the consumable by manipulation of said means.

In accordance with some embodiments described herein, in a second aspect there is provided a system comprising the consumable and a device configured to heat the consumable to generate an aerosol.

In accordance with some embodiments described herein, in a third aspect there is provided a method of separating the additional material from the consumable, comprising pulling or peeling the tab to separate the additional material from the consumable.

In accordance with some embodiments described herein, in a fourth aspect there is provided method of separating a carrier material and a heating element of a consumable, comprising folding the consumable in half along a line of weakness in the carrier material to break the carrier material at the line of weakness, forming two new edges; and peeling back each of the two new edges to remove the carrier material from the heating element

### BRIEF DESCRIPTION OF THE DRAWINGS

FIG. 1 is a schematic illustration of a non-combustible aerosol provision device;

FIG. 2 is a schematic illustration of a system comprising the non-combustible aerosol provision device of FIG. 1 and a consumable;

FIG. 3 is a schematic illustration of an article comprising a heating element for use with the non-combustible aerosol provision device of FIG. 1;

FIG. 4 is a schematic illustration of an article comprising a heating element for use with the non-combustible aerosol provision device of FIG. 1;

FIG. 5 is a schematic illustration of an article comprising a heating element for use with the non-combustible aerosol provision device of FIG. 1;

FIG. 6 is a schematic illustration of an article comprising a heating element for use with the non-combustible aerosol provision device of FIG. 1;

FIG. 7 is an isometric illustration of the article of FIG. 6;

FIG. 8 is a schematic illustration of a non-combustible aerosol provision device;

FIG. 9 is an isometric illustration of an article comprising a heating element for use with the non-combustible aerosol provision device of FIG. 8;

FIG. 10 is a schematic illustration of the article of FIG. 9;

FIG. 11 is a schematic illustration of an article comprising a heating element for use with the non-combustible aerosol provision device of FIG. 1;

FIG. 12 is an isometric illustration of the article of FIG. 11; and

FIG. 13 is an isometric illustration of an article comprising a heating element for use with the non-combustible aerosol provision device of FIG. 8.

### DETAILED DESCRIPTION

According to the present disclosure, a “non-combustible” aerosol provision system is one where a constituent aerosol-generating material of the aerosol provision system (or component thereof) is not combusted or burned in order to facilitate delivery of at least one substance to a user.

In some embodiments, the delivery system is a non-combustible aerosol provision system, such as a powered non-combustible aerosol provision system.

In some embodiments, the non-combustible aerosol provision system is an aerosol-generating material heating system, also known as a heat-not-burn system. An example of such a system is a tobacco heating system.

In some embodiments, the non-combustible aerosol provision system is a hybrid system to generate aerosol using a combination of aerosol-generating materials, one or a plurality of which may be heated. Each of the aerosol-generating materials may be, for example, in the form of a solid, liquid or gel and may or may not contain nicotine. In some embodiments, the hybrid system comprises a liquid or gel aerosol-generating material and a solid aerosol-generating material. The solid aerosol-generating material may comprise, for example, tobacco or a non-tobacco product.

Typically, the non-combustible aerosol provision system may comprise a non-combustible aerosol provision device and a consumable for use with the non-combustible aerosol provision device.

In some embodiments, the disclosure relates to consumables comprising aerosol-generating material and configured to be used with non-combustible aerosol provision devices. These consumables are sometimes referred to as articles throughout the disclosure.

In some embodiments, the non-combustible aerosol provision system, such as a non-combustible aerosol provision device thereof, may comprise a power source and a controller. The power source may, for example, be an electric power source or an exothermic power source. In some embodiments, the exothermic power source comprises a carbon substrate which may be energised so as to distribute power in the form of heat to an aerosol-generating material or to a heat transfer material in proximity to the exothermic power source.

In some embodiments, the non-combustible aerosol provision system may comprise an area for receiving the consumable, an aerosol generator, an aerosol generation area, a housing, a mouthpiece, a filter and/or an aerosol-modifying agent.

In some embodiments, the consumable for use with the non-combustible aerosol provision device may comprise aerosol-generating material, an aerosol-generating material storage area, an aerosol-generating material transfer component, an aerosol generator, an aerosol generation area, a housing, a wrapper, a filter, a mouthpiece, and/or an aerosol-modifying agent.

According to the present disclosure, a “combustible” aerosol provision system is one where a constituent aerosol-generating material of the aerosol provision system (or component thereof) is combusted or burned during use in order to facilitate delivery of at least one substance to a user.

In some embodiments, the delivery system is a combustible aerosol provision system. The combustible aerosol provision system may comprise a consumable or article comprising aerosol-generating material. The consumable may be selected from the group consisting of a cigarette, a cigarillo and a cigar.

In some embodiments, the disclosure relates to a component for use in a combustible aerosol provision system, such as a filter, a filter rod, a filter segment, a tobacco rod, a spill, an aerosol-modifying agent release component such as a capsule, a thread, or a bead, or a paper such as a plug wrap, a tipping paper or a cigarette paper.

In some embodiments, the substance to be delivered comprises an active substance.

The active substance as used herein may be a physiologically active material, which is a material intended to achieve or enhance a physiological response. The active substance may for example be selected from nutraceuticals, nootropics, psychoactives. The active substance may be naturally occurring or synthetically obtained. The active substance may comprise for example nicotine, caffeine, taurine, theine, vitamins such as B6 or B12 or C, melatonin, cannabinoids, or constituents, derivatives, or combinations thereof. The active substance may comprise one or more constituents, derivatives or extracts of tobacco, cannabis or another botanical.

In some embodiments, the active substance comprises nicotine. In some embodiments, the active substance comprises caffeine, melatonin or vitamin B12.

As noted herein, the active substance may comprise or be derived from one or more botanicals or constituents, derivatives or extracts thereof. As used herein, the term “botanical” includes any material derived from plants including, but not limited to, extracts, leaves, bark, fibers, stems, roots, seeds, flowers, fruits, pollen, husk, shells or the like. Alternatively, the material may comprise an active compound naturally existing in a botanical, obtained synthetically. The material may be in the form of liquid, gas, solid, powder, dust, crushed particles, granules, pellets, shreds, strips, sheets, or the like. Example botanicals are tobacco, eucalyptus, star anise, hemp, cocoa, cannabis, fennel, lemongrass, peppermint, spearmint, rooibos, chamomile, flax, ginger, Ginkgo biloba, hazel, hibiscus, laurel, licorice (liquorice), matcha, mate, orange skin, papaya, rose, sage, tea such as green tea or black tea, thyme, clove, cinnamon, coffee, aniseed (anise), basil, bay leaves, cardamom, coriander, cumin, nutmeg, oregano, paprika, rosemary, saffron, lavender, lemon peel, mint, juniper, elderflower, vanilla, wintergreen, beefsteak plant, curcuma, turmeric, sandalwood, cilantro, bergamot, orange blossom, myrtle, cassis, valerian, pimento, mace, damien, marjoram, olive, lemon balm, lemon basil, chive, carvi, verbena, tarragon, geranium, mulberry, ginseng, theanine, theacrine, maca, ashwagandha, damiana, guarana, chlorophyll, baobab or any combination thereof. The mint may be chosen from the following mint varieties: Mentha Arventis, Mentha c.v., Mentha niliaca, Mentha piperita, Mentha piperita citrata c.v., Mentha piperita c.v, Mentha spicata crispa, Mentha cardifolia, Memtha longifolia, Mentha suaveolens variegata, Mentha pulegium, Mentha spicata c.v. and Mentha suaveolens

In some embodiments, the active substance comprises or is derived from one or more botanicals or constituents, derivatives or extracts thereof and the botanical is tobacco.

In some embodiments, the active substance comprises or derived from one or more botanicals or constituents, derivatives or extracts thereof and the botanical is selected from eucalyptus, star anise, cocoa and hemp.

In some embodiments, the active substance comprises or derived from one or more botanicals or constituents, derivatives or extracts thereof and the botanical is selected from rooibos and fennel.

In some embodiments, the substance to be delivered comprises a flavor.

As used herein, the terms “flavor” and “flavorant” refer to materials which, where local regulations permit, may be used to create a desired taste, aroma or other somatosensorial sensation in a product for adult consumers. They may include naturally occurring flavor materials, botanicals, extracts of botanicals, synthetically obtained materials, or combinations thereof (e.g., tobacco, cannabis, licorice (liquorice), hydrangea, eugenol, Japanese white bark magnolia leaf, chamomile, fenugreek, clove, maple, matcha, menthol, Japanese mint, aniseed (anise), cinnamon, turmeric, Indian spices, Asian spices, herb, wintergreen, cherry, berry, red berry, cranberry, peach, apple, orange, mango, clementine, lemon, lime, tropical fruit, papaya, rhubarb, grape, durian, dragon fruit, cucumber, blueberry, mulberry, citrus fruits, Drambuie, bourbon, scotch, whiskey, gin, tequila, rum, spearmint, peppermint, lavender, aloe vera, cardamom, celery, cascarilla, nutmeg, sandalwood, bergamot, geranium, khat, naswar, betel, shisha, pine, honey essence, rose oil, vanilla, lemon oil, orange oil, orange blossom, cherry blossom, cassia, caraway, cognac, jasmine, ylang-ylang, sage, fennel, wasabi, piment, ginger, coriander, coffee, hemp, a mint oil from any species of the genus Mentha, eucalyptus, star anise, cocoa, lemongrass, rooibos, flax, Ginkgo biloba, hazel, hibiscus, laurel, mate, orange skin, rose, tea such as green tea or black tea, thyme, juniper, elderflower, basil, bay leaves, cumin, oregano, paprika, rosemary, saffron, lemon peel, mint, beefsteak plant, curcuma, cilantro, myrtle, cassis, valerian, pimento, mace, damien, marjoram, olive, lemon balm, lemon basil, chive, carvi, verbena, tarragon, limonene, thymol, camphene), flavor enhancers, bitterness receptor site blockers, sensorial receptor site activators or stimulators, sugars and/or sugar substitutes (e.g., sucralose, acesulfame potassium, aspartame, saccharine, cyclamates, lactose, sucrose, glucose, fructose, sorbitol, or mannitol), and other additives such as charcoal, chlorophyll, minerals, botanicals, or breath freshening agents. They may be imitation, synthetic or natural ingredients or blends thereof. They may be in any suitable form, for example, liquid such as an oil, solid such as a powder, or gas.

In some embodiments, the flavor comprises menthol, spearmint and/or peppermint. In some embodiments, the flavor comprises flavor components of cucumber, blueberry, citrus fruits and/or redberry. In some embodiments, the flavor comprises eugenol. In some embodiments, the flavor comprises flavor components extracted from tobacco. In some embodiments, the flavor comprises flavor components extracted from cannabis.

In some embodiments, the flavor may comprise a sensate, which is intended to achieve a somatosensorial sensation which are usually chemically induced and perceived by the stimulation of the fifth cranial nerve (trigeminal nerve), in addition to or in place of aroma or taste nerves, and these may include agents providing heating, cooling, tingling, numbing effect. A suitable heat effect agent may be, but is not limited to, vanillyl ethyl ether and a suitable cooling agent may be, but not limited to eucolyptol, WS-3.

An aerosol-generating material is a material that is capable of generating aerosol, for example when heated, irradiated or energized in any other way. Aerosol-generating material may, for example, be in the form of a solid, liquid or semi-solid (such as a gel) which may or may not contain an active substance and/or flavorants.

The aerosol-generating material may comprise a binder and an aerosol former. Optionally, an active and/or filler may also be present. Optionally, a solvent, such as water, is also present and one or more other components of the aerosol-generating material may or may not be soluble in the solvent. In some embodiments, the aerosol-generating material is substantially free from botanical material. In particular, in some embodiments, the aerosol-generating material is substantially tobacco free.

The aerosol-generating material may comprise or be an “amorphous solid”. The amorphous solid may be a “monolithic solid”. In some embodiments, the amorphous solid may be a dried gel. The amorphous solid is a solid material that may retain some fluid, such as liquid, within it. In some embodiments, the aerosol-generating material may, for example, comprise from about 50 wt %, 60 wt % or 70 wt % of amorphous solid, to about 90 wt %, 95 wt % or 100 wt % of amorphous solid.

The aerosol-generating material may comprise or be an aerosol-generating film. The aerosol-generating film may be formed by combining a binder, such as a gelling agent, with a solvent, such as water, an aerosol-former and one or more other components, such as active substances, to form a slurry and then heating the slurry to volatilize at least some of the solvent to form the aerosol-generating film. The slurry may be heated to remove at least about 60 wt %, 70 wt %, 80 wt %, 85 wt % or 90 wt % of the solvent. The aerosol-generating film may be a continuous film or a discontinuous film, such an arrangement of discrete portions of film on a support. The aerosol-generating film may be substantially tobacco free.

The aerosol-generating film may comprise or be a sheet, which may optionally be shredded to form a shredded sheet.

The aerosol-generating material may comprise one or more active substances and/or flavors, one or more aerosol-former materials, and optionally one or more other functional material.

The aerosol-generating material may comprise one or more active substances and/or flavors, one or more aerosol-former materials, and optionally one or more other functional material.

The aerosol-former material may comprise one or more constituents capable of forming an aerosol. In some embodiments, the aerosol-former material may comprise one or more of glycerine, glycerol, propylene glycol, diethylene glycol, triethylene glycol, tetraethylene glycol, 1,3-butylene glycol, erythritol, meso-Erythritol, ethyl vanillate, ethyl laurate, a diethyl suberate, triethyl citrate, triacetin, a diacetin mixture, benzyl benzoate, benzyl phenyl acetate, tributyrin, lauryl acetate, lauric acid, myristic acid, and propylene carbonate.

The one or more other functional materials may comprise one or more of pH regulators, coloring agents, preservatives, binders, fillers, stabilizers, and/or antioxidants.

The material may be present on or in a support, to form a substrate. The support may, for example, be or comprise paper, card, paperboard, cardboard, reconstituted material, a plastics material, a ceramic material, a composite material, glass, a metal, or a metal alloy. In some embodiments, the support comprises a susceptor. In some embodiments, the susceptor is embedded within the material. In some alternative embodiments, the susceptor is on one or either side of the material.

A consumable is an article comprising or consisting of aerosol-generating material, part or all of which is intended to be consumed during use by a user. A consumable may comprise one or more other components, such as an aerosol-generating material storage area, an aerosol-generating material transfer component, an aerosol generation area, a housing, a wrapper, a mouthpiece, a filter and/or an aerosol-modifying agent. A consumable may also comprise an aerosol generator, such as a heater, that emits heat to cause the aerosol-generating material to generate aerosol in use. The heater may, for example, comprise combustible material, a material heatable by electrical conduction, or a susceptor.

An aerosol-modifying agent is a substance, typically located downstream of the aerosol generation area, that is configured to modify the aerosol generated, for example by changing the taste, flavor, acidity or another characteristic of the aerosol. The aerosol-modifying agent may be provided in an aerosol-modifying agent release component, that is operable to selectively release the aerosol-modifying agent

The aerosol-modifying agent may, for example, be an additive or a sorbent. The aerosol-modifying agent may, for example, comprise one or more of a flavorant, a colorant, water, and a carbon adsorbent. The aerosol-modifying agent may, for example, be a solid, a liquid, or a gel. The aerosol-modifying agent may be in powder, thread or granule form. The aerosol-modifying agent may be free from filtration material.

An aerosol generator is an apparatus configured to cause aerosol to be generated from the aerosol-generating material. In some embodiments, the aerosol generator is a heater configured to subject the aerosol-generating material to heat energy, so as to release one or more volatiles from the aerosol-generating material to form an aerosol. In some embodiments, the aerosol generator is configured to cause an aerosol to be generated from the aerosol-generating material without heating. For example, the aerosol generator may be configured to subject the aerosol-generating material to one or more of vibration, increased pressure, or electrostatic energy.

In the figures described herein, like reference numerals are used to illustrate equivalent features, articles or components.

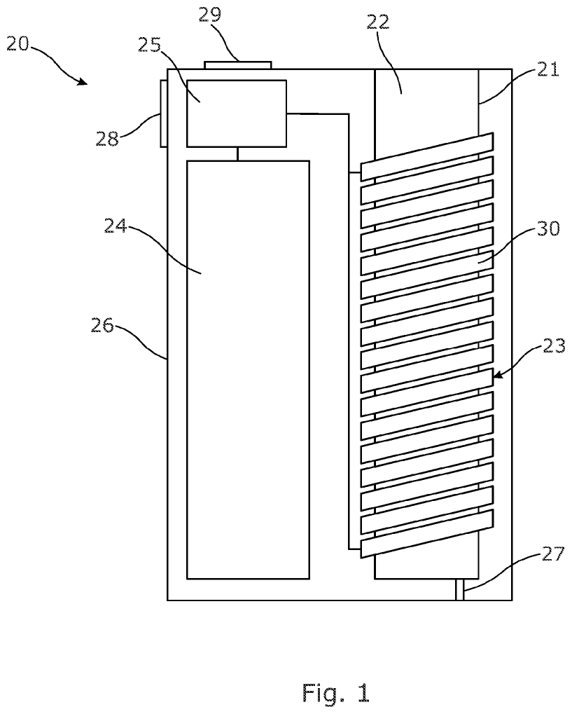

A non-combustible aerosol provision device 20 (herein referred to simply as the ‘device 20’) is shown schematically in FIG. 1. The device 20 comprises a wall 21 that defines a rod shaped consumable receiving space 22 (herein referred to simply as ‘receiving space 22’); and a heater 23 configured to heat the consumable receiving space 22.

The device further comprises a power source 24 and a control unit 25 which are configured to power and control the heater 23, respectively. The power source 24 may be, for example, a battery 24, such as a rechargeable battery or a non-rechargeable battery. Examples of suitable batteries include, for example, a lithium battery (such as a lithium-ion battery), a nickel battery (such as a nickel-cadmium battery), and an alkaline battery.

The various components of the device, including the heater 23, receiving space 22, battery 24 and control unit 25 are retained within a housing 26.

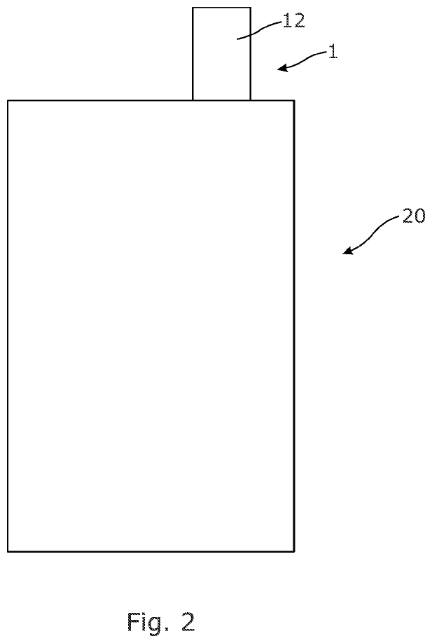

The device 20 is of the approximate size and shape to allow a user to hold the device 20 in a single hand. In use, a consumable 1 comprising an aerosol generating material 5 is inserted into the receiving space 22 and heated by the heater 23. The heat causes one or more volatiles from the aerosol-generating material 5 to form an aerosol. A mouth end 12 of the consumable protrudes from the device as illustrated by FIG. 2. To inhale the aerosol generated by the heated consumable 1, a user draws on the mouth end 12 of the consumable 1, in the manner of a conventional cigarette.

The device further comprises an inlet 27 as shown in FIG. 1. When a user draws on the consumable 1, air is drawn from the inlet 27 and through the consumable.

The device 20 further comprises a first activation button 28 to allow a user to turn the device 20 on or off, and a second activation button 29 to activate the heater 23. To use the device 20, a user draws on the mouth end 12 of the consumable 1 while simultaneously pressing the second activation button 29 to cause the heater 23 to heat the consumable 1 and generate an aerosol.

The inlet 27 may comprise a pressure sensor (not shown) which acts as a ‘puff sensor’. The puff sensor is configured to detect a drop in pressure at the air inlet 27 which indicates that a user is drawing on a consumable 1 located within the receiving space 22. The device 20 is thereby configured to activate the heater 23 in response to a drop in pressure detected at the air inlet 27.

The control unit 25 is configured to direct electrical energy from the battery 24 to activate the heater 23 in response to an input signal.

In one example, the input signal is generated when the second activation button 29 is pressed by the user. In another embodiment, the input signal is generated when a pressure drop is detected at the inlet 27 by a pressure sensor.

The heater 23 may be an inductive heating assembly 23 and comprise various components to heat the consumable receiving space via an inductive heating process. Induction heating is a process of heating an electrically conducting object (such as a susceptor) by electromagnetic induction. An induction heating assembly may comprise an inductive element, for example, one or more inductor coils, and a device for passing a varying electric current, such as an alternating electric current, through the inductive element. The varying electric current in the inductive element produces a varying magnetic field. The varying magnetic field penetrates a susceptor suitably positioned with respect to the inductive element, and generates eddy currents inside the susceptor. The susceptor has electrical resistance to the eddy currents, and hence the flow of the eddy currents against this resistance causes the susceptor to be heated by Joule heating. In cases where the susceptor comprises ferromagnetic material such as iron, nickel or cobalt, heat may also be generated by magnetic hysteresis losses in the susceptor, i.e. by the varying orientation of magnetic dipoles in the magnetic material as a result of their alignment with the varying magnetic field. In inductive heating, as compared to heating by conduction for example, heat is generated inside the susceptor, allowing for rapid heating. Further, there need not be any physical contact between the inductive heater and the susceptor, allowing for enhanced freedom in construction and application.

In the example illustrated by FIG. 1, the inductive heating assembly comprises an inductor coil 30. The inductor coil 30 is made from an electrically conducting material. For example, the inductor coil 30 may be made from Litz wire/cable which is wound in a helical fashion about the wall 21. Litz wire comprises a plurality of individual wires which are individually insulated and are twisted together to form a single wire. Litz wires are designed to reduce the skin effect losses in a conductor. The inductor coil 30 is made from copper Litz wire which has a rectangular cross section. In other examples the Litz wire can have other shape cross sections, such as circular. The inductor coil 30 is configured to generate a varying magnetic field for heating a susceptor.

The described embodiments provide means 9, 64 accessible to a user of a consumable 1, 50 to allow an additional material 4, 52, 60 of the consumable 1, 50 to be removed from the consumable 1, 50 by manipulation of said means 9, 64, as will be explained further below.

By ‘additional material’, it is meant a material with a different recycling requirement and/or monetary value to those other materials of the consumable that the additional material is embedded in, attached to, adhered to, laminated to, or otherwise connected to. The additional material may be a metallic or non-metallic material. Where a metallic material, the additional material may be a ferrous material or a non-ferrous material.

By ‘accessible to a user’, it is meant that said means can be accessed to serve the purpose of allowing the additional material to be separated from said other materials of the consumable without undue burden. In other words, the user shall not be required to use means not provided to them with the consumable, such as any instructions or tools. That is to say, the user is not required to use their own tools or initiative to disassemble the consumable, but is able to do so with the information or tools provided to them with the consumable. By way of example, ‘accessible to the user’ can include means that are initially concealed from the user, but are accessible on removal of a further component of the consumable, where said removal of said further component is achievable by following simple instructions provided with the consumable. This may include removal of a wrapper or similar. This may also include inserting the consumable into a device such as a non-combustible aerosol provision device, wherein removal of the additional material occurs on removal of a portion of the consumable from the device.

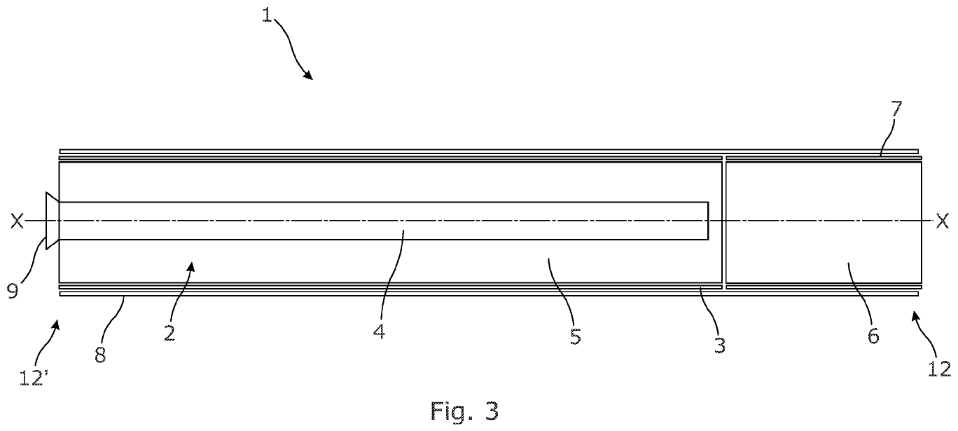

FIG. 3 shows an article 1 that, in some embodiments, form part of a non-combustible aerosol provision system comprising the article 1 and the non-combustible aerosol provision device 20. The article 1 is rod shaped and comprises a mouth end 12 and a distal end 12′, opposite the mouth end 12.

The article 1 comprises an aerosol generating section 2 circumscribed by a wrapper 3. In the illustrated embodiment, a heating element 4 extends axially within the aerosol generating section 2. The heating element 4 is a susceptor comprising a material configured for heating by induction. Therefore, when the article 1 is inserted into the non-combustible aerosol provision device 20, the heating element 4 is inductively heated by the heater 23 of the device 20 to heat the aerosol generating section 2. Heat from the heating element 4 is transferred from the heating element 4 to aerosol generating material 5 of the aerosol generating section 2 to generate an aerosol for inhalation by a user.

The article of FIG. 1 further comprises a filter plug 6 arranged in coaxial alignment with the aerosol generating section 2 and attached thereto by a paper wrapper 8 that circumscribes the length of the article 1. The filter plug 6 may additionally be wrapped in a plug wrap 7 disposed in between the filter plug 6 and the paper wrapper 8. Such articles 1 are typically discarded following use. There is an environmental benefit if consumer participation of recycling can be encouraged.

The heating element 4 may be made from any material suitable for induction heating. In the present example, the heating element is made from a ferrous material, such as steel. Such materials must be separated from the aerosol generating section 2 for recycling.

The present invention provides a tab 9 accessible to a user of the consumable to allow the heating element 4 to be removed from the consumable by manipulation of the tab 9. In the example of FIG. 1, the tab 9 is an extension of the heating element 4 that protrudes from an axial face of the distal 12′ end of the article 1. Therefore, a user can grip the tab 9 to pull the heating element 4 from the article 1 so that it is separated from the article 1 for recycling. In particular, a user can grip the tab 9 and pull the tab 9 in an axial direction away from the axial end of the article 1 to cause the heating element 4 to slide out from within the aerosol generating section 2. It is therefore preferable that the heating element 4 comprises a smooth outer surface so as to slide from the aerosol generating section without catching on aerosol generating material 5 of the aerosol generating section 2. The heating element 4 may be a cuboid, a rod or any other suitable shape. In some embodiments the heating element 4 may comprise a flat profile. By ‘flat profile’ it is meant that the heating element 4 is a cuboid having a thickness significantly smaller than a width or length of the heating element 4.

Therefore, the heating element 4 resembles a thin, flat strip.

The aerosol generating material 5 of the aerosol generating section 2 may comprise a solid aerosol-forming substrate, the solid aerosol-forming substrate may comprise one or more of: powder, granules, pellets, shreds, spaghetti strands, strips or sheets containing one or more of: herb leaf, tobacco leaf, fragments of tobacco ribs, reconstituted tobacco, homogenized tobacco, extruded tobacco and expanded tobacco. The solid aerosol-forming substrate may be in loose form. The aerosol-forming substrate may comprise a plug of solid aerosol-forming substrate.

In the embodiment illustrated by FIG. 1, the aerosol generating material 5 comprises one or more sheets of homogenized tobacco material that has been gathered into a rod, circumscribed by the wrapper 3, and cut to provide the aerosol generating section 2.

Preferably, the homogenized tobacco material comprises a crimped and gathered sheet of homogenized tobacco material. Preferably, folds formed in the crimped and gathered sheet extend in an axial direction through the aerosol generating section 2. Therefore, the crimped and gathered sheet of homogenized tobacco material does not obstruct axial movement of the heating element 4 when it is removed by the tab 9. The homogenized tobacco material may comprise at least one of fibers, binder and aerosol former. Preferably, the sheet of homogenized tobacco material is a cast leaf. Cast leaf is a form of reconstituted tobacco that is formed from a slurry including tobacco particles, fiber particles, aerosol former, and binder. The cast leaf may additionally comprise one or more flavors.

In some embodiments, the article comprises additional segments arranged in coaxial alignment with the aerosol generating section 2 and filter plug 7 and attached thereto by a series of overlapping wrapping materials.

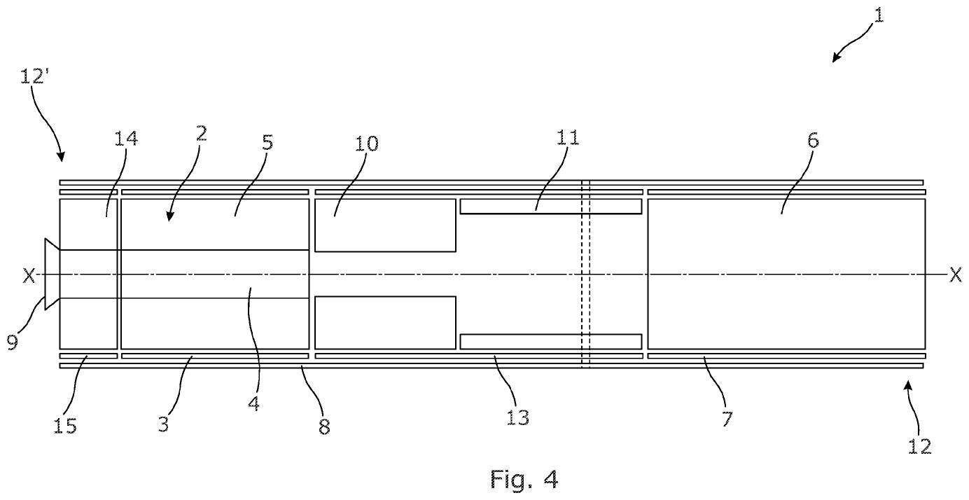

In an embodiment illustrated by FIG. 4, in which like features retain the same reference numbers, the article 1 further comprises a cooling segment 10 and an expansion segment 11.

The cooling segment 10 and the expansion segment 11 are disposed between the aerosol generating section 2 and the filter plug 7. The cooling segment 10 is directly adjacent the aerosol generating section 2. The expansion segment 11 is disposed between the cooling segment 10 and the filter plug 7 and is directly adjacent to both. A wrapping material 13 extends over both segments 10, 11 and is disposed in between the segments 10, 11 and the paper wrapper 8.

Also illustrated by FIG. 4 is a distal end plug 14. The distal end plug 14 is provided to prevent condensate from seeping out of the distal end 12′ of the article 1 and into the receiving space 22 of the aerosol provision device 20 during use. The distal end plug 14 is provided with its own plug wrap 15 and is adjoined to a distal end 12′ of the aerosol generating section 2 by the paper wrapper 3. The heating element 4 extends through the distal end plug 14 and out of the distal end 12′ of the article 1, terminating at the tab 19. The paper wrapper 3 is adhered to the plug wrap 15 to ensure the distal end plug 14 remains in place throughout use of the article 1, including during removal of the heating element 4.

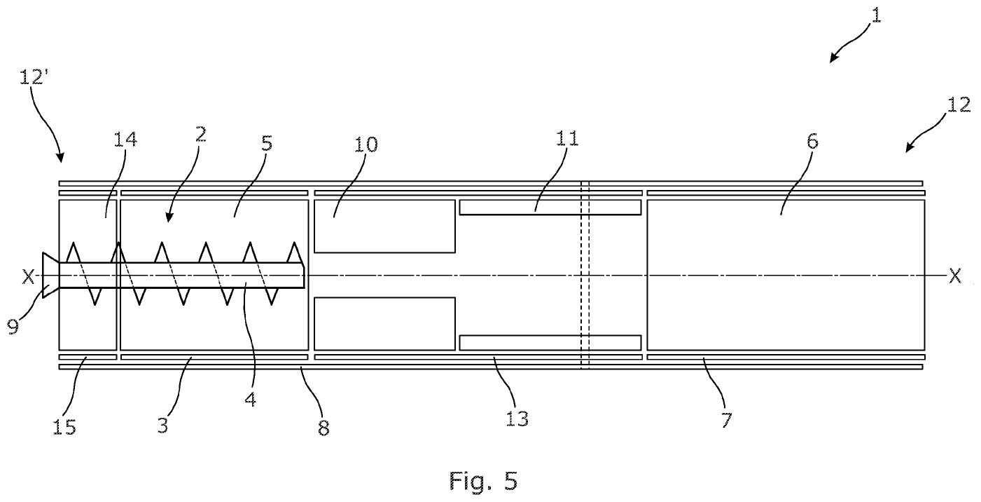

In an embodiment illustrated by FIG. 5, in which like features retain the same reference numbers, the heating element 4 is threaded. Therefore, manipulation of the tab 9 to allow removal of the heating element 4 may comprise rotating the tab 9 to unscrew the heating element 4 from the aerosol generating section 2.

In some embodiments, the tab 9 may be formed from an insulating material. By insulating material, it is meant a material having a thermal conductivity that is less than the remaining part of the heating element 4. In some embodiments, the tab 9 may be formed from a material that is not susceptible to induction heating. The object of such embodiments is to prevent the tab from becoming too hot to handle following heating of the article 1 in the device 20 so that the tab 9 may be manipulated by a user to facilitate removal of the heating element 4 from the article 1. In some embodiments, the aerosol generating device 20 and the article 1 are configured so that, when the article 1 is received in the device 20, the heater 23 of the device 20 is arranged to generate a varying magnetic field that penetrates only the aerosol generating section 2 of the article 1. Therefore, the heating element 4 is only heated by induction in the region of the aerosol generating section 2. In such embodiments, the heater 23 does not directly heat the tab 9 by induction, or indeed heat the heating element 4 in the region of the distal end plug 14, where provided.

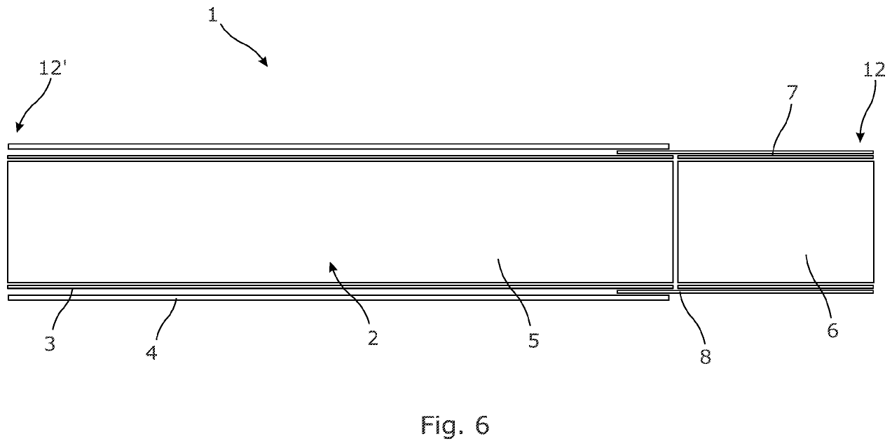

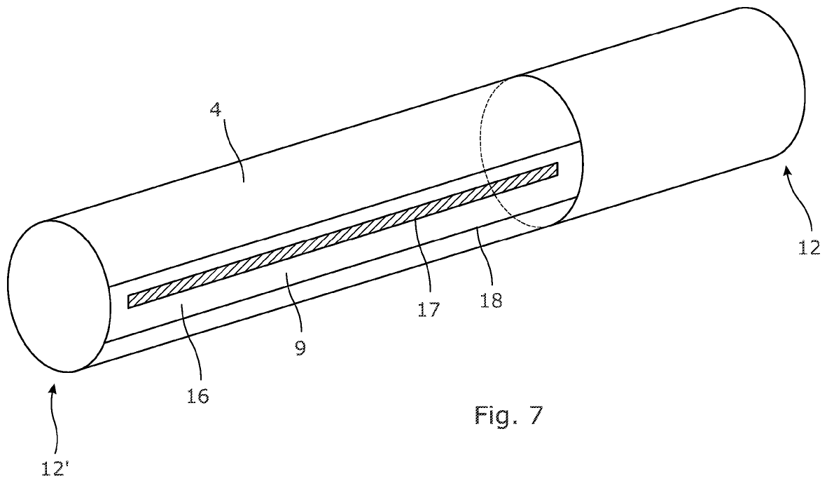

In an embodiment illustrated by FIGS. 6 and 7, in which like features retain the same reference numbers, the heating element 4 comprises a wrapping material that circumscribes the aerosol generating section 2. The heating element 4 is a susceptor comprising a material configured for heating by induction, such as a metal foil. Therefore, when the article 1 is inserted into the non-combustible aerosol provision device 20, the heating element 4 is inductively heated by the heater 23 of the device 20 to heat the aerosol generating section 2. Heat from the heating element 4 is transferred from the heating element 4 to aerosol generating material 5 of the aerosol generating section 2 to generate an aerosol for inhalation by a user. In the illustrated embodiment, the heating element 4 that extends within the aerosol generating material (as shown in FIGS. 3 to 5) is not present, but may be provided if additional heating is required.

As in the above embodiments, in the embodiment of FIGS. 6 and 7, the aerosol generating section 2 is connected to further components of the article by a paper wrapper 8 that overlies the aerosol generating section 2 and said further components. In the illustrated embodiment, said further components consists of a filter plug 6, though it will be appreciated that any of the cooling segment 10, expansion segment 11 or distal end plug 14 may be further combined with the article 1 of FIGS. 6 and 7, if required.

In the illustrated embodiment, the paper wrapper 8 extends only partially along the length of the aerosol generating section 2. In one example, the paper wrapper 8 extends along the aerosol generating section 2 only to the extent required to attach the aerosol generating section 2 to said further components of the article 1. Therefore, the paper wrapper does not overlie a region of the aerosol generating section 2. This means that said region of the aerosol generating section 2 is separated from the heating element 4 only by the wrapper 3 that circumscribes the aerosol generating section 2. The advantage of this is that the paper wrapper 8 does not impede heat transfer between the heating element 4 circumscribing the aerosol generating section 2 and the aerosol generating material 5.

The heating element 4 of FIGS. 6 and 7 is the outermost wrapping material circumscribing the aerosol generating section 2. Therefore, the heating element 4 is accessible to a user to separate it for recycling.

The heating element 4 of FIGS. 6 and 7 is formed from a quadrilateral strip of susceptor material that is wrapped around the aerosol generating section 2 during assembly of the article 1. Opposing edges of the susceptor material overlap, forming a lap seam 16—as illustrated by FIG. 7. A strip of adhesive 17 is disposed between the overlapping edges to adhere the overlapping edges to each other. The strip of adhesive 17 extends in an axial direction of the article 1 and is spaced from an outer most edge 18 of the lap seam 16. Therefore, the outermost edge 18 of the lap seam 16 forms a free edge 18 which can be gripped and lifted by a user to break adhesion of the overlapping edges and remove the heating element 4 from the article 1 for recycling. In this way, a tab 9 is formed between the adhesive strip 17 and the outermost edge 18 of the lap seam which is accessible to a user of the consumable to allow the heating element 4 to be removed from the consumable by manipulation of the tab 9.

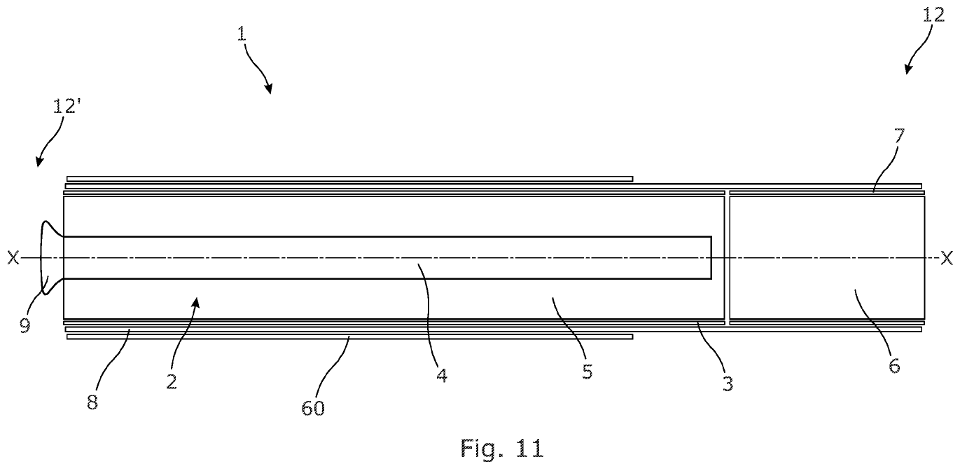

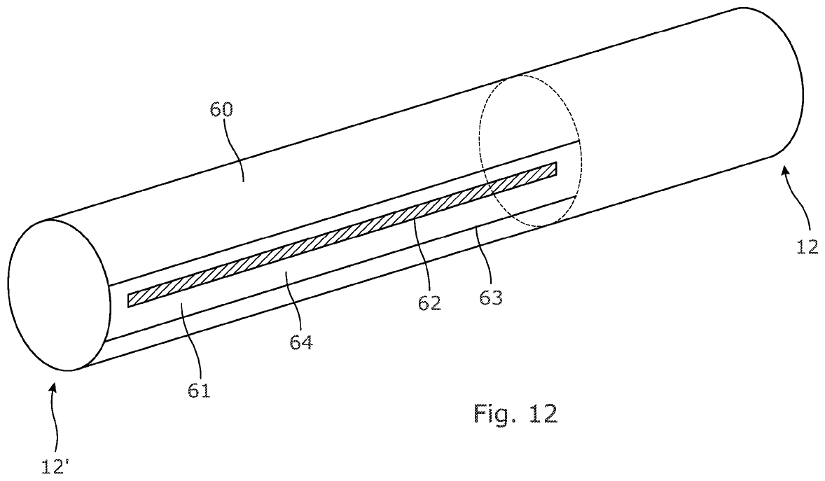

In an embodiment illustrated by FIGS. 11 and 12, in which like features retain the same reference numbers, an article 1 is provided with a non-combustible wrapping material 60 that circumscribes a portion of the article 1. The non-combustible wrapping material 60 is configured to prevent a user mistaking the article 1 for a conventional cigarette from lighting the distal end 12′ of the article 1. Therefore, the non-combustible wrapping material 60 extends from the distal end 12′ of the article 1 and over a portion of the length of the article 1. The illustrated article 1 is substantially as described with reference to FIG. 3, but with the addition of the non-combustible wrapping material 60. However, a non-combustible wrapping material 60 may circumscribe a length of any of the articles of FIGS. 3 to 5. It will be appreciated that a non-combustible wrapping material 60 is not required for the embodiments of FIGS. 6 and 7 where the heating element 4 is inherently non-combustible, such as a metal foil. Indeed, the non-combustible wrapping material 60 may comprise a metal foil. In some embodiments, the non-combustible wrapping material 60 is an aluminium foil.

As per the heating element 4, the non-combustible wrapping material is ideally to be separated from the article 1 before disposal of the article 1 to allow the non-combustible wrapping material 60 to be separately disposed of or recycled.

The non-combustible wrapping material 60 is formed from a quadrilateral strip of non-combustible material that is wrapped around the article 1 during assembly of the article 1.

Opposing edges of the non-combustible wrapping material 60 overlap, forming a lap seam 61—as illustrated by FIG. 12. A strip of adhesive 62 is disposed between the overlapping edges to adhere the overlapping edges to each other. The strip of adhesive 62 extends in an axial direction of the article 1 and is spaced from an outer most edge 63 of the lap seam 61.

Therefore, the outermost edge 63 of the lap seam 61 forms a free edge 63 which can be gripped and lifted by a user to break adhesion of the overlapping edges and remove the non-combustible wrapping material 60 from the article 1 for recycling. In this way, a tab 64 is formed between the adhesive strip 62 and the outermost edge 63 of the lap seam 61 which is accessible to a user of the consumable 1 to allow the non-combustible wrapping material 60 to be removed from the consumable 1 by manipulation of the tab 64.

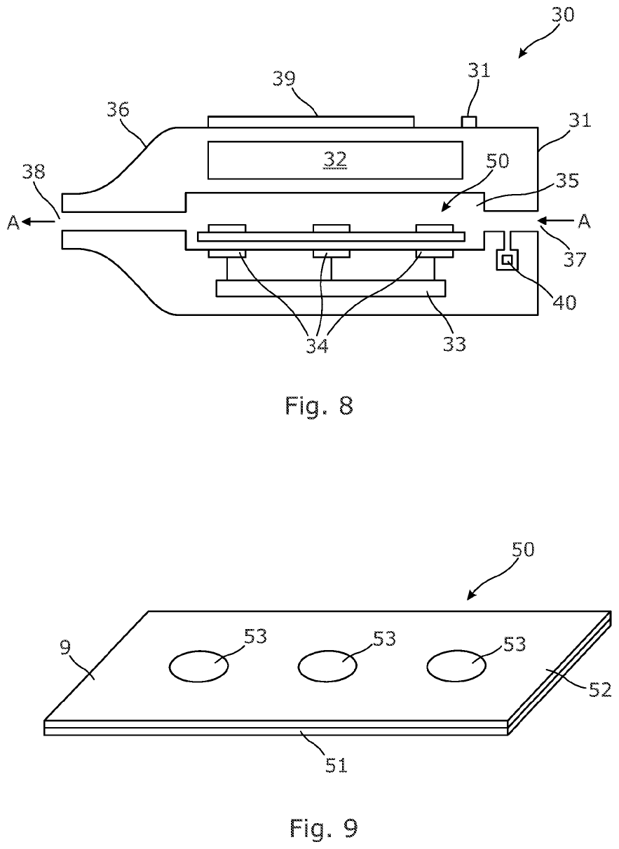

FIGS. 8 to 10 illustrate alternative embodiments of an aerosol provision system comprising a non-combustible aerosol provision device 30 and a consumable 50 for use with the device.

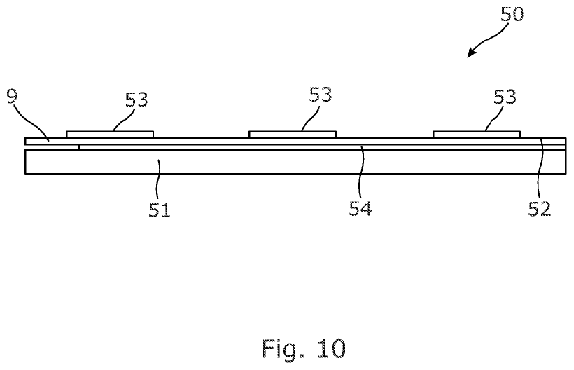

FIG. 8 is a cross-sectional view through a schematic representation of the aerosol provision device 30. FIGS. 9 and 10 show the consumable 40 for use in the device 30. The aerosol provision device 30 comprises an outer housing 31, a power source 32, control circuitry 33, a plurality of aerosol generating components 34, a receptacle or aerosol forming chamber 35, a mouthpiece end 36, an air inlet 37, an air outlet 38, an activation button 39 and an inhalation sensor 40. The outer housing 31 is arranged such that the power source 32, control circuitry 33, aerosol generating components 34, receptacle 35 and inhalation sensor 40 are located within the outer housing 31. The outer housing 31 also defines the air inlet 37 and air outlet 38, described in more detail below. The activation button 29 is located on the exterior of the outer housing 31.

The power source 32 is configured to provide operating power to the aerosol provision device 30. The power source 32 may be any suitable power source, such as a battery. For example, the power source 32 may comprise a rechargeable battery, such as a lithium ion battery. The control circuitry 33 is suitably configured or programmed to control the operation of the aerosol provision device 30 and distribute power from the power source 32 to other components of the device 30.

FIGS. 9 and 10 illustrate the consumable 50. The consumable 50 (also herein referred to as article 50) comprises a carrier material 51, a heating element 52 and aerosol generating material 53 disposed on the heating element 52. In the present example, the carrier material 51 is made of card and is the main structural component of the article 50, providing the article 50 with sufficient rigidity to maintain its shape in normal handling, such as inserting and removing the article 50 from the aerosol provision device 30. The carrier material 51 is broadly cuboidal in shape and comprises a substantially flat profile. By ‘flat profile’ it is meant that the thickness of the carrier material 51 is less than its width and length. By way of a concrete example, the length of the carrier material 51 may be 30 to 80 mm, the width may be 7 to 25 mm, and the thickness may be between 0.2 to 1 mm. However, it should be appreciated that the above are exemplary dimensions of the carrier material 51, and in other implementations the carrier material 51 may have different dimensions as appropriate.

The heating element 52 is adhered to the carrier material 51. The heating element 52 comprises a thin strip of material that is suitable for inductive heating. In the illustrated embodiments, the heating element 52 has substantially the same length and width as the carrier material 51 so that the heating element 52 can be superimposed on top of the carrier material 51 and adhered thereto.

FIG. 10 shows a cross section through the article 50. An adhesive layer 54 is provided between the heating element 52 and carrier material 51 to adhere the heating element 52 and the carrier material 51 to each other. Part of the heating element 52 is not adhered to the carrier material 51, thereby providing a tab 9 of the heating element 52 that is free for a user to lift away from the carrier material 51. Therefore a user can peel back the heating element 52 from the carrier material 51, separating the heating element 52 from the carrier material 51 for recycling. In the illustrated embodiment, a region between the carrier material 51 and heating element 52 is free of adhesive to provide the tab 9. However, it will be appreciated that in other embodiments the carrier material 51 and the heating element 52 may be adhered to each other over the entire area of overlap between the carrier material 51 and heating element 52. In such embodiments, the tab 9 may instead be provided by extension of the heating element 52 beyond the carrier material 51. The adhesive used in the adhesive layer 54 is selected so as to have a bond strength that prevents separation of the heating element 52 from the carrier material 51 during insertion and removal of the article 50 from the device 30, but is weak enough to enable a user of normal dexterity to peel the heating element 52 away from the carrier material 51 when required.

A plurality of discreet portions of the aerosol generating material 53 are provided directly on the heating element 52. Although three circular portions of aerosol generating material 53 are provided, it will be appreciated that any number may be provided as required. For example, in another implementation, a two by three array of discreet portions of aerosol generating material 53 are provided. Importantly, the number and spacing of aerosol generating portions 53 matches the number and spacing of aerosol generating components 34 in the device 30 so that, when the article 50 is correctly installed in the receptacle 35, the aerosol generating portions 53 are disposed directly above the aerosol generating components 34.

Although not shown in FIG. 8, the device 30 may comprise a lid portion and a base portion which are configured to engage with one another to secure an article 50 within the receptacle 35. Various configurations for the lid and base portions are considered, for example, although not shown in FIG. 8, the device 30 may comprise a hinged door or removable part of the outer housing 31 to permit access to the receptacle 35 such that a user may insert and/or remove the article 50 from the receptacle 35. The hinged door or removable part of the outer housing 31 may also act to retain the article 50 within the receptacle 35 when closed.

In the described implementation, the aerosol generating material 53 comprises a gelling agent (sometimes referred to as a binder) and an aerosol former material (which might comprise glycerol, for example). Optionally, the aerosol generating material may comprise one or more of the following: an active substance (which may include a tobacco extract), a flavorant, an acid, and a filler. Other components may also be present as desired.

In the described implementation, the aerosol generating components 34 are inductive heaters configured to generate a varying magnetic field to induce eddy currents in the heating element 52 immediately below the discreet portions of aerosol generating material 53.

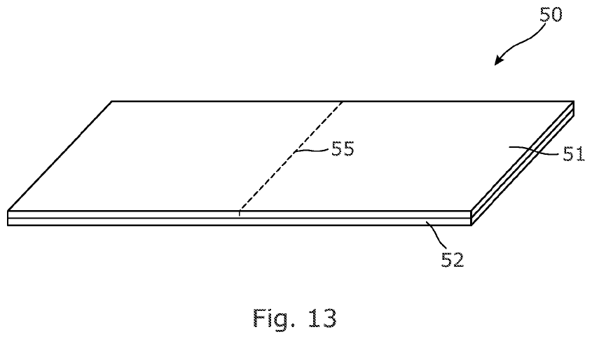

In an embodiment illustrated by FIG. 13, in which like features retain the same reference numbers, the carrier material 51 further comprises a line of weakness 55 that bisects the carrier material 51. The line of weakness 55 preferably extends across the width of the carrier material 51, as illustrated. The line of weakness 55 is configured to cause the carrier material 51 to separate into two parts when the article 50 is folded in half along the line of weakness 55. In particular, when the article 50 is folded in half so that the line of weakness 55 is on the outside of the fold, tension in the carrier material 51 results in the carrier material 51 breaking in two along the line of weakness 55. The break in the carrier material 51 produces two new edges in the carrier material 51 which are exposed for a user to manipulate to peel the carrier material 51 from the heating element 52. The line of weakness 55 may be a partial cut in the carrier material 51. Alternatively, the line of weakness 55 may be a perforated cut in the carrier material 51. The line of weakness 55 may be provided instead of the tab 9 discussed above, or in addition to the tab 9.

To use the device 30, an article 50 is inserted into the receptacle 35 and the device 30 is switched on by way of a sensor (not shown) determining that the article 50 is present in the receptacle 35. Alternatively, the device 30 may be switched on by user interaction with the activation button 39. The user then draws on the mouth end 36 of the device 30, inducing a flow of air through the inlet 37, into the receptacle 35 and out through the outlet 38 for inhalation. The inhalation sensor 40 determines a pressure drop at the inlet 37 and generates a signal which is transmitted to the control circuitry 33. In turn, the control circuitry 33 distributes power from the power source 32 to the aerosol generating components 34 which heat the heating element 52 as described. Heat from the heating element 52 vaporizes volatile elements of the discreet portions of aerosol generating material 53 which are entrained into the flow of air through the device 30 for inhalation. The control circuitry 33 may be configured to distribute power to all of the aerosol generating components 34 at once or, more preferably, in sequence. Therefore, each portion of aerosol generating material 53 is heated at a different time. Preferably, each portion of aerosol generating material 53 is heated for a predetermined time, or for a predetermined number of puffs, before the adjacent portion of aerosol generating material 53 is heated. Once each portion of aerosol generating material 53 has been heated for predetermined time, or predetermined number of puffs, the article 50 can be removed and replaced.

The various embodiments described herein are presented only to assist in understanding and teaching the claimed features. These embodiments are provided as a representative sample of embodiments only, and are not exhaustive and/or exclusive. It is to be understood that advantages, embodiments, examples, functions, features, structures, and/or other aspects described herein are not to be considered limitations on the scope of the invention as defined by the claims or limitations on equivalents to the claims, and that other embodiments may be utilized and modifications may be made without departing from the scope of the claimed invention. Various embodiments of the invention may suitably comprise, consist of, or consist essentially of, appropriate combinations of the disclosed elements, components, features, parts, steps, means, etc, other than those specifically described herein. In addition, this disclosure may include other inventions not presently claimed, but which may be claimed in future.

1. A consumable comprising an aerosol generating material and an additional material different to the aerosol generating material, wherein the consumable comprises a means accessible to a user of the consumable to allow the additional material to be removed from the consumable by manipulation of said means.

2. A consumable according to claim 1, wherein said means comprises a tab.

3. A consumable according to claim 2, wherein the consumable is a rod shaped article comprising an aerosol generating section.

4. A consumable according to claim 2, wherein the additional material is a heating element for heating the aerosol generating material.

5. A consumable according to claim 4, wherein the heating element is a susceptor comprising a material configured for heating by induction.

6. A consumable according to claim 5, wherein the tab is formed from a material that is not susceptible to induction heating.

7. A consumable according to claim 4, wherein the heating element is formed of a steel.

8. A consumable according to claim 4, wherein the tab is formed from a material having a lower coefficient of conductivity than a remaining portion of the heating element.

9. A consumable according to claim 4, wherein the heating element extends axially within the aerosol generating section of the article.

10. A consumable according to claim 4, wherein the tab is an extension of the heating element.

11. A consumable according to claim 10, wherein the tab extends from an axial end of the article.

12. A consumable according to claim 4, wherein the heating element comprises a thin strip of material.

13. A consumable according to claim 1, wherein the aerosol generating material comprises one or more sheets of homogenized tobacco material.

14. A consumable according to claim 13, wherein the sheets of homogenized tobacco material are crimped and gathered into a rod of homogenized tobacco material, wherein the homogenized tobacco material comprises fold lines that extend in an axial direction of the rod of homogenized tobacco material.

15. A consumable according to claim 1, wherein the article comprises a filter plug in coaxial alignment with the aerosol generating section and is attached thereto by a paper wrapper.

16. A consumable according to claim 1, wherein the additional material is a wrapping material that circumscribes a portion of the article.

17. A consumable according to claim 16, wherein the wrapping material is a non-combustible material.

18. A consumable according to claim 16, wherein the wrapping material is a heating element for heating the aerosol generating material.

19. A consumable according to claim 18, wherein the wrapping material is a susceptor comprising a material configured for heating by induction.

20. A consumable according to claim 16, wherein opposing edges of the wrapping material overlap to form a lap seam and wherein adhesive is provided between the overlapping edges to adhere the overlapping edges to each other, the adhesive being spaced from an outer most edge of the lap seam so that the outer most edge is free for a user to grip and lift said free edge and break adhesion of the overlapping edges for removal of the wrapping material from the consumable.

21. A consumable according to claim 1, wherein the consumable comprises a carrier material and wherein the additional material is a heating element disposed on the carrier material.

22. A consumable according to claim 21, wherein the aerosol generating material comprises discreet portions of aerosol generating material disposed on the heating element.

23. A consumable according to claim 21, wherein the heating element is adhered to the carrier material by a layer of adhesive.

24. A consumable according to claim 21, wherein said means comprises a tab.

25. A consumable according to claim 23, wherein a portion of the heating element is not adhered to the carrier material.

26. A consumable according to claim 25, wherein the portion of the heating element extends beyond the carrier material.

27. A consumable according to claim 25, wherein the portion of the heating element overlaps the carrier material.

28. A consumable according to claim 21, wherein said means comprises a line of weakness that bisects the carrier material.

29. A consumable according to claim 1, wherein the aerosol generating material comprises a binder and an aerosol former material.

30. A system comprising a consumable according to claim 1 and a device configured to heat the consumable to generate an aerosol.

31. A method of separating the additional material from the consumable of claim 1, comprising:
pulling or peeling the tab to separate the additional material from the consumable.

32. A method of separating the carrier material and the heating element of claim 28, comprising:
folding the consumable in half along the line of weakness to break the carrier material at the line of weakness, forming two new edges; and
peeling back each of the two new edges to remove the carrier material from the heating element.
